(19) United States
(12) Patent Application Publication
(10) Pub. No.: US 2025/0176022 A1
(43) Pub. Date: May 29, 2025

(54) PROVIDING A TRIGGER SIGNAL IN RESPONSE TO A REQUEST TO SEND FOR EFFICIENT UPLINK RESOURCE UTILIZATION

(71) Applicant: QUALCOMM Incorporated, San Diego, CA (US)

(72) Inventors: Ahsel Ahmed Madari, Kozhikode (IN); Vijayakumar Balasubramanian, Chennai (IN); Mani Krishnan Venkatachari, Chennai (IN)

(21) Appl. No.: 18/523,146

(22) Filed: Nov. 29, 2023

(51) Int. Cl. H04W 74/0816; H04B 7/0452; H04W 74/08

(52) U.S. Cl. CPC H04W 74/0816; H04B 7/0452; H04W 74/0866

(57) ABSTRACT

This disclosure provides methods, components, devices and systems for providing a trigger signal in response to a request to send. Some aspects more specifically relate to utilizing available uplink channel bandwidth, spatial streams, or a combination thereof in response to a request to send (RTS). In some examples, a wireless station may transmit a RTS signal requesting a subchannel bandwidth of a channel bandwidth supported by the wireless access point. Additionally or alternatively, a wireless station supporting fewer spatial streams than are supported by an AP may transmit a RTS signal The wireless access point may, responsive to the RTS signal, transmit a trigger signal to multiple wireless stations allocating bandwidth of the communication channel determined to be clear with respect to the RTS, allocating a number of spatial streams supported by the AP, or a combination thereof.

### TECHNICAL FIELD

This disclosure relates generally to wireless communication, and more specifically, to providing a trigger signal in response to a request to send, such as for efficient uplink resource utilization.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless access point. The wireless access point device includes a processing system that includes one or more processors and one or more memories coupled with the one or more processors. The processing system may be configured to cause the wireless access point to receive, from a first wireless station, a request to send (RTS) signal in a first portion of a communication bandwidth in which the wireless access point performs wireless communications with a plurality of wireless stations including the first wireless station. The processing system also may be configured to cause the wireless access point to transmit, to the first wireless station and one or more other wireless stations of the plurality of wireless stations, a trigger signal corresponding to the RTS signal for allocating at least a first portion of resources of the communication bandwidth to the first wireless station for a transmit opportunity with respect to the communication bandwidth and further allocating one or more other portions of the resources of the communication bandwidth to the one or more other wireless stations for the transmit opportunity.

In some examples, the processing system is configured to cause the wireless access point to sense that the first portion of the communication bandwidth and the one or more other portions of the communication bandwidth meet criteria for communication availability. According to some examples, the first portion of the resources of the communication bandwidth includes a first portion of the communication bandwidth that is less bandwidth than is currently available from a prospective of the wireless access point for a transmit opportunity and the one or more other portions of the resources of the communication bandwidth include one or more other portions of the communication bandwidth currently available for the transmit opportunity. The RTS signal of some examples is received in the first portion of the communication bandwidth, and the trigger signal corresponding to the RTS signal allocates the first portion of the communication bandwidth to the first wireless station for the transmit opportunity and one or more other portions of the communication bandwidth to the one or more other wireless stations for the transmit opportunity. In accordance with some examples, the communication bandwidth includes a first channel, the first portion of the resources of the communication bandwidth includes a first subchannel within the first channel, and the one or more other portions of the resources of the communication bandwidth include one or more other subchannels of the first channel. According to some examples, the first subchannel and the one or more other subchannels span a full bandwidth of the first channel. In accordance with some examples, the processing system is configured to cause the wireless access point to receive, from the first wireless station and the one or more other wireless stations of the plurality of wireless stations corresponding to the trigger signal, a multi-user trigger- based physical layer protocol data unit (MU TB-PPDU). According to some examples, the first wireless station supports a first number of spatial streams that is less than a second number of spatial streams supported by the wireless access point with respect to the communication bandwidth. The first portion of the resources of the communication bandwidth of some examples includes the first number of spatial streams, and the trigger signal corresponding to the RTS signal allocates the first number of spatial streams in the communication bandwidth to the first wireless station for the transmit opportunity and other spatial streams of the second number of spatial streams in the communication bandwidth to the one or more other wireless stations for the transmit opportunity. In accordance with some examples, the processing system is configured to cause the wireless access point to receive, from the first wireless station and the one or more other wireless stations of the plurality of wireless stations corresponding to the trigger signal, an uplink multi-user multiple-input multiple-output (UL MU-MIMO) signal.

Another innovative aspect of the subject matter described in this disclosure can be implemented in a wireless station. The wireless station includes a processing system that includes one or more processors and one or more memories coupled with the one or more processors. The processing system may be configured to cause the wireless station to transmit, to a wireless access point, a RTS signal in a first portion of a communication bandwidth in which the wireless access point performs wireless communications with a plurality of wireless stations including the wireless station. The processing system also may be configured to cause the wireless station to receive, from the wireless access point, a trigger signal corresponding to the RTS signal for allocating at least a first portion of resources of the communication bandwidth to the wireless station for a transmit opportunity with respect to the communication bandwidth and further allocating one or more other portions of the resources of the communication bandwidth to one or more other wireless stations for the transmit opportunity.

In some examples, the first portion of the communication bandwidth and the one or more other portions of the communication bandwidth meet criteria for communication availability prior to receiving the trigger signal. According to some examples, the first portion of the resources of the communication bandwidth includes a first portion of the communication bandwidth that is less bandwidth than is currently available from a prospective of the wireless access point for a transmit opportunity and the one or more other portions of the resources of the communication bandwidth include one or more other portions of the communication bandwidth currently available for the transmit opportunity. The RTS signal of some examples is transmitted in the first portion of the resources of the communication bandwidth, and the trigger signal corresponding to the RTS signal allocates the first portion of the communication bandwidth to the wireless station for the transmit opportunity and the one or more other portions of the communication bandwidth to the one or more other wireless stations for the transmit opportunity. In accordance with some examples, the communication bandwidth includes a first channel, the first portion of the resources of the communication bandwidth includes a first subchannel within the first channel, and the one or more other portions of the resources of the communication bandwidth include one or more other subchannels of the first channel. According to some examples, the first subchannel and the one or more other subchannels span a full bandwidth of the first channel. In accordance with some examples, the processing system is configured to cause the wireless access point to receive, from the first wireless station and the one or more other wireless stations of the plurality of wireless stations corresponding to the trigger signal, a MU TB-PPDU. According to some examples, the wireless station supports a first number of spatial streams that is less than a second number of spatial streams supported by the wireless access point with respect to the communication bandwidth. The first portion of the resources of the communication bandwidth of some examples includes the first number of spatial streams, and the trigger signal corresponding to the RTS signal allocates the first number of spatial streams in the communication bandwidth to the wireless station for the transmit opportunity and other spatial streams of the second number of spatial streams in the communication bandwidth to the one or more other wireless stations for the transmit opportunity. In accordance with some examples, the processing system is configured to cause the wireless station to transmit, to the wireless access point in correspondence to the trigger signal, a portion of an UL MU-MIMO signal.

Another innovative aspect of the subject matter described in this disclosure can be implemented in a method for wireless communication by a wireless access point. The method includes receiving, from a first wireless station, a RTS signal in a first portion of a communication bandwidth in which the wireless access point performs wireless communications with a plurality of wireless stations including the first wireless station. The method also may include transmitting, to the first wireless station and one or more other wireless stations of the plurality of wireless stations, a trigger signal corresponding to the RTS signal for allocating at least a first portion of resources of the communication bandwidth to the first wireless station for a transmit opportunity with respect to the communication bandwidth and further allocating one or more other portions of the resources of the communication bandwidth to the one or more other wireless stations for the transmit opportunity.

In some examples, the method may include sensing that the first portion of the communication bandwidth and the one or more other portions of the communication bandwidth meet criteria for communication availability. According to some examples, the first portion of the resources of the communication bandwidth includes a first portion of the communication bandwidth that is less bandwidth than is currently available from a prospective of the wireless access point for a transmit opportunity and the one or more other portions of the resources of the communication bandwidth includes one or more other portions of the communication bandwidth currently available for the transmit opportunity. The RTS signal of some examples is received in the first portion of the communication bandwidth, and the trigger signal corresponding to the RTS signal allocates the first portion of the communication bandwidth to the first wireless station for the transmit opportunity and one or more other portions of the communication bandwidth to the one or more other wireless stations for the transmit opportunity. In accordance with some examples, the communication bandwidth includes a first channel, the first portion of the resources of the communication bandwidth includes a first subchannel within the first channel, and the one or more other portions of the resources of the communication bandwidth include one or more other subchannels of the first channel. According to some examples, the first subchannel and the one or more other subchannels span a full bandwidth of the first channel. In accordance with some examples, the method may include receiving, from the first wireless station and the one or more other wireless stations of the plurality of wireless stations corresponding to the trigger signal, a MU TB-PPDU. According to some examples, the first wireless station supports a first number of spatial streams that is less than a second number of spatial streams supported by the wireless access point with respect to the communication bandwidth. The first portion of the resources of the communication bandwidth of some examples includes the first number of spatial streams, and the trigger signal corresponding to the RTS signal allocates the first number of spatial streams in the communication bandwidth to the first wireless station for the transmit opportunity and other spatial streams of the second number of spatial streams in the communication bandwidth to the one or more other wireless stations for the transmit opportunity. In accordance with some examples, the method includes receiving, from the first wireless station and the one or more other wireless stations of the plurality of wireless stations corresponding to the trigger signal, an UL MU-MIMO signal.

Another innovative aspect of the subject matter described in this disclosure can be implemented in a method for wireless communication by a wireless station. The method includes transmitting, to a wireless access point, a RTS signal in a first portion of a communication bandwidth in which the wireless access point performs wireless communications with a plurality of wireless stations including the wireless station. The method also may include receiving, from the wireless access point, a trigger signal corresponding to the RTS signal for allocating at least a first portion of resources of the communication bandwidth to the wireless station for a transmit opportunity with respect to the communication bandwidth and further allocating one or more other portions of the resources of the communication bandwidth to one or more other wireless stations for the transmit opportunity.

In some examples, the method may include the first portion of the communication bandwidth and the one or more other portions of the communication bandwidth meeting criteria for communication availability prior to receiving the trigger signal. According to some examples, the first portion of the resources of the communication bandwidth includes a first portion of the communication bandwidth that is less bandwidth than is currently available from a prospective of the wireless access point for a transmit opportunity and the one or more other portions of the resources of the communication bandwidth include one or more other portions of the communication bandwidth currently available for the transmit opportunity. The RTS signal of some examples is transmitted in the first portion of the resources of the communication bandwidth, and the trigger signal corresponding to the RTS signal allocates the first portion of the communication bandwidth to the wireless station for the transmit opportunity and the one or more other portions of the communication bandwidth to the one or more other wireless stations for the transmit opportunity. In accordance with some examples, the communication bandwidth includes a first channel, the first portion of the resources of the communication bandwidth includes a first subchannel within the first channel, and the one or more other portions of the resources of the communication bandwidth include one or more other subchannels of the first channel. According to some examples, the first subchannel and the one or more other subchannels span a full bandwidth of the first channel. In accordance with some examples, the method includes receiving, from the first wireless station and the one or more other wireless stations of the plurality of wireless stations corresponding to the trigger signal, a MU TB-PPDU. According to some examples, the wireless station supports a first number of spatial streams that is less than a second number of spatial streams supported by the wireless access point with respect to the communication bandwidth. The first portion of the resources of the communication bandwidth of some examples includes the first number of spatial streams, and the trigger signal corresponding to the RTS signal allocates the first number of spatial streams in the communication bandwidth to the wireless station for the transmit opportunity and other spatial streams of the second number of spatial streams in the communication bandwidth to the one or more other wireless stations for the transmit opportunity. In accordance with some examples, the includes transmitting, to the wireless access point in correspondence to the trigger signal, a portion of an UL MU-MIMO signal.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless access point (AP) and one or more wireless stations (STAs).

FIG. 3 shows a hierarchical format of an example PPDU usable for communications between a wireless AP and one or more wireless STAs.

FIG. 4 shows an example basic trigger frame usable by a wireless AP to initiate and synchronize transmissions from multiple wireless STAs.

FIG. 5A shows a timing diagram illustrating an example request to send/clear to send (RTS/CTS) process in which the RTS is for a smaller bandwidth subchannel of a larger bandwidth channel.

FIG. 5B shows a timing diagram illustrating an example RTS/CTS process in which the RTS is made by a STA supporting fewer spatial streams than are supported by the AP.

FIG. 6A shows a timing diagram illustrating an example RTS/trigger process for utilizing available uplink channel bandwidth in response to a subchannel bandwidth request to send.

FIG. 6B shows a timing diagram illustrating an example RTS/trigger process for utilizing a number of spatial streams supported by an AP in response to a RTS from a STA supporting a lesser number of spatial streams.

FIG. 7 shows a flowchart illustrating an example process performable by or at a wireless STA that supports operation providing a trigger signal in response to a request to send.

FIG. 8 shows a flowchart illustrating an example process performable by or at a wireless AP that supports operation providing a trigger signal in response to a request to send.

FIG. 9 shows a block diagram of an example wireless communication device that supports operation providing a trigger signal in response to a request to send.

FIG. 10 shows a block diagram of an example wireless communication device that supports operation providing a trigger signal in response to a request to send.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single- carrier FDMA (SC-FDMA), spatial division multiple access (SDMA), rate-splitting multiple access (RSMA), multi-user shared access (MUSA), single-user (SU) multiple- input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In some WLANs, wireless access point may operate with one or more relatively large bandwidth channels. For example, wireless access point may operate with a 160 MHz or 320 MHz primary channel. However, a wireless station in the basic service set (BSS) of the wireless access point may be unable to utilize the full bandwidth of a large bandwidth channel supported by the wireless access point. For example, a wireless station may observe that its secondary clear channel assessment (CCA) is busy at a particular point when the wireless station has data for uplink transmission, a wireless station may transmit at a reduced bandwidth for reliable communications when disposed relatively far from the wireless access point, etc. A wireless station may therefore, in some situations, request a smaller bandwidth subchannel of the larger bandwidth channel. For example, a wireless station having data for uplink transmission may transmit a request to send (RTS) for a subchannel (for example, 20 MHz or 40 MHz subchannel) of a channel bandwidth (for example, 160 MHz or 320 MHz) supported by wireless access point. In response to the RTS, the wireless access point may operate to sense the channel bandwidth and, if determined to be clear (for example, CCA), transmit a clear to send (CTS) to the wireless station for the subchannel. The remainder of the communication bandwidth, even if clear and otherwise available for communications, may be unutilized during a transmission opportunity.

Additionally or alternatively, in some WLANs, wireless access point may support a relatively large number of spatial streams (NSSs). For example, wireless access point may support 4, 8, or 16 spatial streams with respect to a communication bandwidth. However, one or more wireless stations in the BSS of the wireless access point may support a lesser number of spatial streams. For example, a wireless station may support a maximum of 1, 2, or 3 spatial streams. A wireless access point may be provided information regarding the number of spatial streams supported by wireless stations, such as from NSS capability information included in an association request from the wireless station. A wireless access point may therefore allocate a number of spatial streams corresponding to the maximum number of spatial streams supported by a wireless station in response to a RTS. The remainder of the spatial streams supported by the wireless access point, despite the wireless access point having the capability to support a number of spatial streams greater than those allocated to the wireless station, may be unutilized during a transmission opportunity.

Various aspects relate generally to providing a trigger signal in response to a RTS. Operation providing a trigger signal in response to a RTS according to some examples of the disclosure facilitates or otherwise enables efficient uplink resource utilization. For example, a RTS/trigger process may provide for efficient utilization of available communication bandwidth, efficient utilization of spatial streams, or a combination thereof.

Some aspects relate to utilizing available uplink channel bandwidth in response to a subchannel bandwidth RTS. In some examples, a wireless station having data for uplink transmission may transmit a RTS signal to a wireless access point. The RTS may request a subchannel bandwidth of a channel bandwidth supported by the wireless access point. Having received a RTS signal, the wireless access point may operate to sense the channel bandwidth for availability with respect to a transmit opportunity (or transmission opportunity (TxOP)), (for example, determined to be clear according to CCA operation). Responsive to the RTS signal, the wireless access point of some examples transmits a trigger signal (for example, a signal in accordance with a trigger frame of the IEEE 802.11 family of wireless communication protocol standards) to multiple wireless stations if the communication channel is determined by the wireless access point to be clear with respect to the RTS.

Some aspects, additionally or alternatively, relate to utilizing a number of spatial streams supported by a wireless access point in excess of a number of spatial streams supported by a wireless station making a request to send. In some examples, a wireless station having data for uplink transmission may transmit a RTS signal to a wireless access point. The wireless station may support a number of spatial streams less than the number of spatial streams supported by the wireless access point. Having received a RTS signal, the wireless access point may operate to detect, determine, or otherwise ascertain a number of spatial streams supported by the wireless station (for example, determined from NSS capability information for the wireless station) for use with respect to a TxOP. Responsive to the RTS signal, the wireless access point of some examples transmits a trigger signal (for example, a signal in accordance with a trigger frame of the IEEE 802.11 family of wireless communication protocol standards) to multiple wireless stations if the number of spatial streams supported by the wireless station is less than the number of spatial streams supported by the wireless access point.

In operation according to some examples, a wireless access point may sense the communication channel and detect, determine, or otherwise ascertain that the full bandwidth of the communication channel is clear. In another example, the wireless access point may sense the communication channel and detect, determine, or otherwise ascertain that the subchannel bandwidth of the RTS and one or more other subchannel bandwidths within the communication channel are clear. The wireless access point of some examples may thus transmit a trigger signal allocating the subchannel bandwidth corresponding to the RTS for uplink communication by the wireless station and allocating one or more subchannel bandwidths of the communication channel also determined to be clear to one or more other wireless stations (for example, the wireless stations in a BSS of the wireless access point). For example, instead of, rather than, or in place of transmitting a CTS signal to the wireless station in response to the RTS, the wireless access point may transmit a trigger signal to multiple wireless stations facilitating use of clear bandwidth of the communication channel in addition to that of the subchannel of the RTS.

In operation according to some examples, a wireless access point may detect, determine, or otherwise ascertain that the full bandwidth of the communication channel is clear. In another example, the wireless access point may sense the communication channel and detect, determine, or otherwise ascertain that a number of spatial streams in excess to the number of spatial streams supported by a wireless station corresponding to the RTS are available. The wireless access point of some examples may thus transmit a trigger signal allocating the number of spatial streams supported by the wireless station to the wireless station and allocating one or more additional spatial streams, as supported by the wireless access point, one or more other wireless stations (for example, the wireless stations in a BSS of the wireless access point). For example, instead of, rather than, or in place of transmitting a CTS signal to the wireless station in response to the RTS, the wireless access point may transmit a trigger signal to multiple wireless stations facilitating use of spatial streams in addition to spatial streams to be used by the wireless station having made the RTS. According to some aspects, the trigger signal may both facilitate use of clear bandwidth of the communication channel in addition to that of the subchannel of the RTS and use of spatial streams in addition to spatial streams to be used by the wireless station having made the RTS.

According to some examples, multiple wireless stations receive the trigger signal from the wireless access point allocating subchannel bandwidths of the communication channel to the wireless stations. For example, the wireless station having transmitted the RTS signal may receive the trigger signal in response to the RTS signal (for example, a trigger signal corresponding to the RTS signal, for allocating the subchannel bandwidth, for allocating a number of spatial streams supported by the wireless station, or a combination thereof, transmitted instead of or rather than receiving a CTS signal), while one or more other wireless stations also may receive the trigger signal (for example, the trigger signal corresponding to the RTS signal, allocating one or more other subchannels, allocating one or more spatial streams in addition to the number of spatial streams supported by the wireless station, or a combination thereof, and which is unprovoked by or not in response to transmissions by the other wireless stations). Having received a trigger signal, the wireless stations may operate to transmit uplink signals to the wireless access point using the allocated subchannels. In operation according to some examples, the wireless station and the other wireless stations may transmit respective portions of a multi-user trigger-based physical layer protocol data unit (MU TB-PPDU) to the wireless access point. In operation according to some examples, the wireless station and the other wireless stations may transmit respective portions of an uplink MU-MIMO (UL MU-MIMO) signal to the wireless access point.

Particular aspects of the subject matter described in this disclosure can be implemented to realize one or more of the following potential advantages. In some examples, by providing a trigger to multiple wireless stations in accordance with some aspects of the disclosure, wastage of air-time, bandwidth, streams, and combinations thereof may be mitigated or otherwise avoided. For example, by providing a trigger to multiple wireless stations rather than a CTS to a wireless station requesting a subchannel of a channel having bandwidth available in addition to the requested subchannel, additional available bandwidth of a communication channel may be utilized. As another example, by providing a trigger to multiple wireless stations rather than a CTS to a wireless station requesting to send an uplink signal which supports fewer streams than supported by a wireless access point, additional streams supported by the wireless access point may be utilized. Further, communication latency may be reduced with respect to the other wireless stations receiving a trigger responsive to a RTS for a subchannel according to some examples.

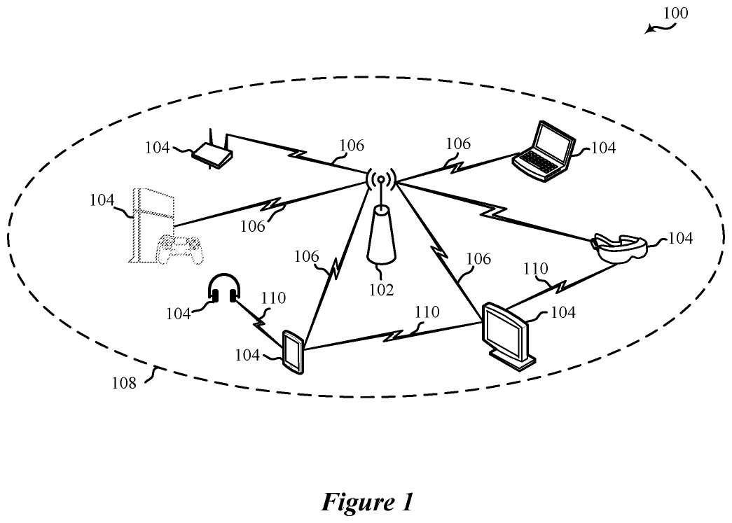

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non- standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

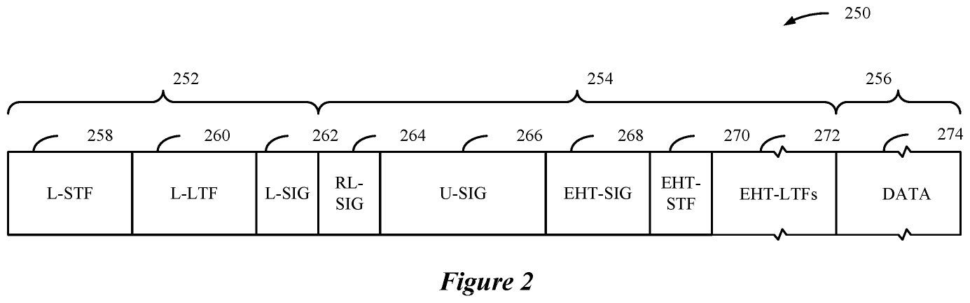

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT-or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version- dependent information for, other wireless communication protocol versions associated with amendments to the IEEE family of standards beyond EHT. For example, U-SIG 266 may be used by a receiving device (such as the AP 102 or the STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT- STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (for example, STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

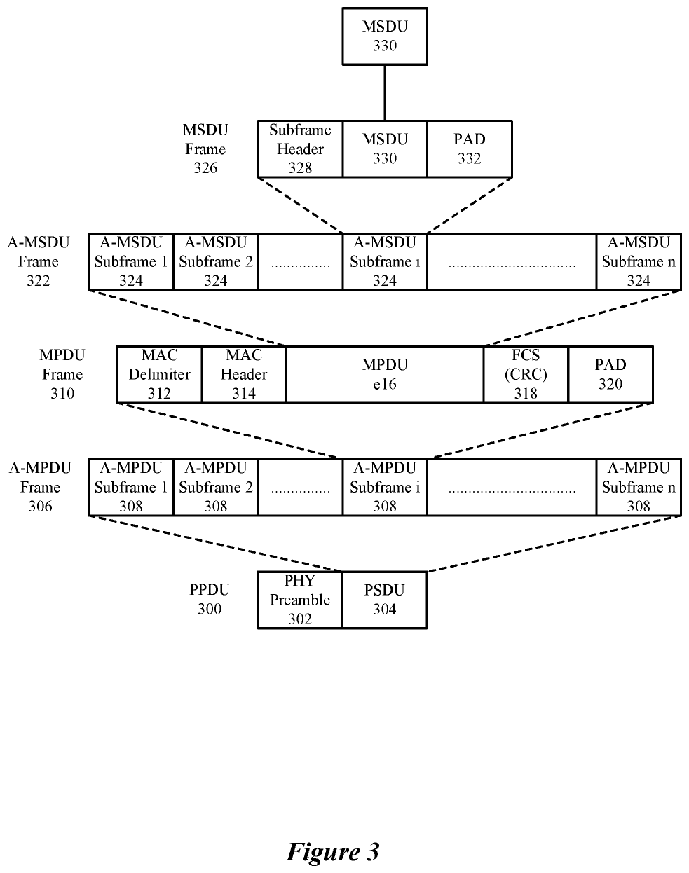

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TxOP) and may begin transmitting. The TxOP is the duration of time the wireless communication device can transmit frames over the channel after it has “won” contention for the wireless medium. The TxOP duration may be indicated in the U-SIG field of a PPDU. If, on the other hand, one or more of the carrier sense mechanisms indicate that the channel is busy, a MAC controller within the wireless communication device will not permit transmission.

APs and STAs (for example, the AP 102 and the STAs 104 described with reference to FIG. 1) that include multiple antennas may support spatial multiplexing, which may be used to increase the spectral efficiency and the resultant throughput of a transmission. To implement spatial multiplexing, the transmitting device divides the data stream into a number Nss of separate, independent spatial streams. The spatial streams are then separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may then perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU- MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access RUs that unscheduled STAs 104 may contend for.

The IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. According to some examples, a TB PPDU transmitted in response to a trigger frame may be a multi-user (MU) TB PPDU in accordance with PPDU 300 shown in FIG. 3.

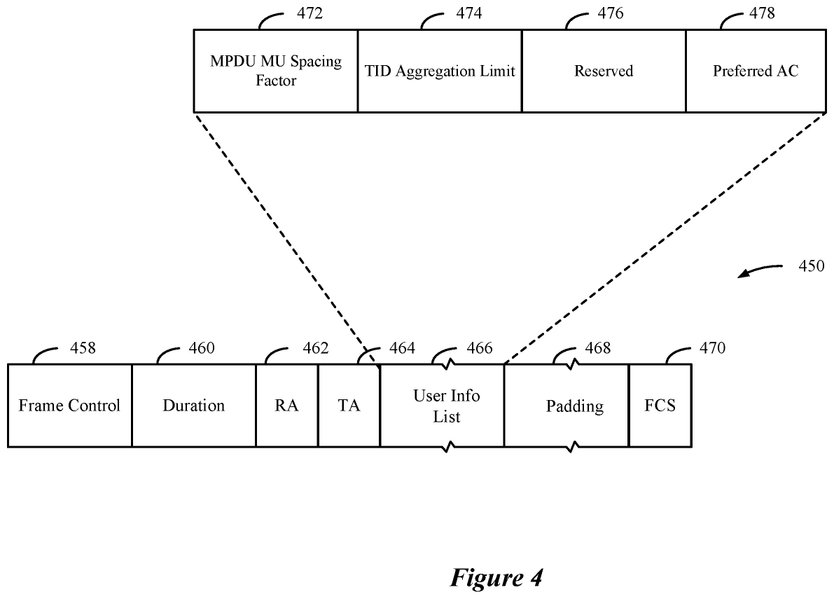

FIG. 4 shows an example basic trigger frame 450 usable by a wireless AP to initiate and synchronize transmissions from multiple wireless STAs. For example, the AP and STAs may be examples of the AP 102 and the STAs 104 described with reference to FIG. 1. The basic trigger frame 450 shown in FIG. 4 is in accordance with a basic trigger frame of IEEE 802.11 standards, as may be implemented by the AP 102 and the plurality of STAs 104. As shown, the basic trigger frame 450 includes the frame control field 458, the duration field 460, the destination and address 1 (RA) field 462, the address 2 (TA) field 464, the user information list field 466, the padding field 468, and the FCS field 470. The frame control field 458 may include frame control information such as protocol version, frame type and subtype, to/from distribution system information, retry information, power management information, etc. The duration field 460 may include a NAV serving to reserve the wireless medium for transmissions by the multiple STAs during the indicated duration. The RA field 462 may include address information (for example, MAC addresses) for the multiple STAs. The TA field 464 may include address information (for example, MAC address) for the AP transmitting the trigger frame. The user information list field 466 of the illustrated example includes MPDU MU spacing factor subfield 472, traffic identifier (TID) aggregation limit subfield 474, reserved subfield 476, and preferred access controller (AC) subfield 478. The padding field 468 may include a number of bits to fill up an unused portion of the trigger frame data structure. The FCS field 470 may include bits added to the trigger frame for error detection. The MPDU MU spacing factor subfield 472 may include information used in calculating the value by which the minimum MPDU start spacing is multiplied. The TID aggregation limit subfield 474 may include information regarding the MPDUs allowed in an A-MPDU carried in a TB PPDU (for example, an A-MPDU of A-MPDU frame 306 in PPDU 300 shown in FIG. 3) and the maximum number of TIDs that can be aggregated by a STA in the A-MPDU. The preferred AC subfield 478 may provide information indicating the lowest AC that is recommended for aggregation of MPDUs in the A-MPDU contained in a TB PPDU sent as a response to the trigger frame.

In some wireless communications systems, an AP 102 may allocate or assign multiple Rus to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment).

As Wi-Fi is not the only technology operating in the 6 GHz band, the use of multiple Rus in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two Rus allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because Rus may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate Rus to the single user, thereby avoiding the punctured channels. In some other examples, U-SIG may be used to indicate SU preamble puncturing. For example, the SU preamble puncturing may be indicated by a value of the EHT-SIG compression field in U-SIG.

In facilitating communication within a wireless communication network, an AP may operate with one or more relatively large bandwidth channels. For example, the AP 102 may operate with a relatively large bandwidth channel (for example, 80 MHz, 160 MHz, 240 MHz, 320 MHz, 480 MHz, or 640 MHz bandwidth primary channel) for communication with respect to the STAs 104 of the wireless communication network 100 shown in FIG. 1. Such channels may, for example, used to support communication links with one or more wireless communication devices (for example, other wireless APs, wireless STAs, etc.). In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components.

One or more of the STAs may be unable to utilize the full bandwidth of a large bandwidth channel supported by an associated AP. For example, a STA of the STAs 104 may observe that its secondary CCA is busy at a particular point when the STA has data for uplink transmission, a STA of the STAs 104 may transmit at a reduced bandwidth for reliable communications when disposed relatively far from the AP 102, etc. Such a STA may therefore request a smaller bandwidth subchannel of the larger bandwidth channel. For example, a STA of the STAs 104 having data for uplink transmission may transmit a RTS to the AP 102 for a subchannel bandwidth (for example, 20 MHz or 40 MHz subchannel) of a channel bandwidth (for example, 80 MHz, 160 MHz, 240 MHz, 320 MHz, 480 MHz, or 640 MHz) supported by the AP.

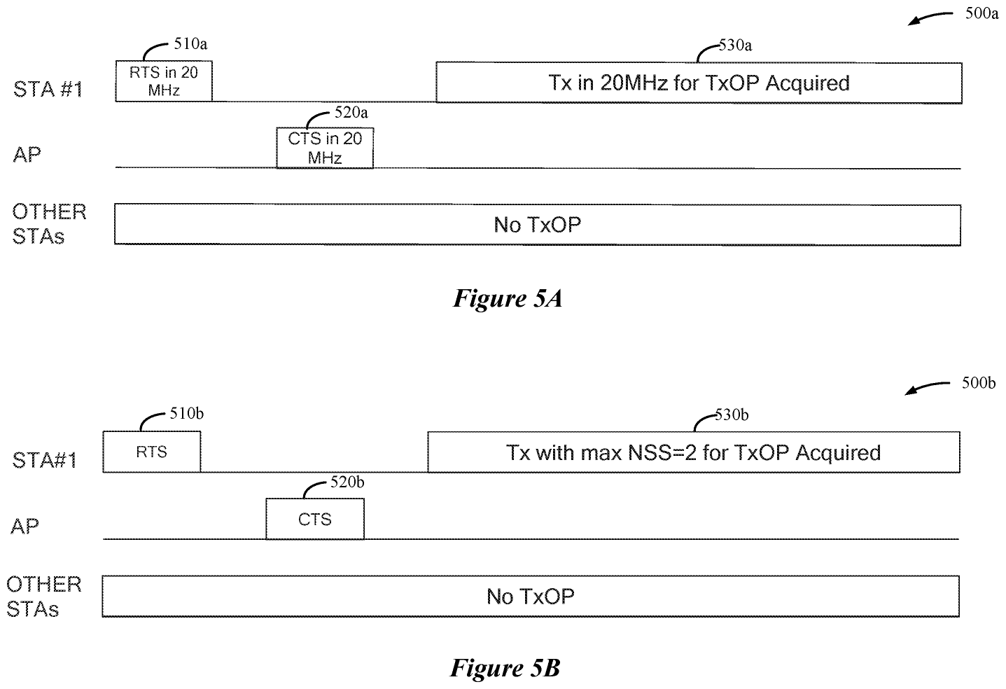

FIG. 5A shows a timing diagram illustrating an example RTS/CTS process 500a in which the RTS is for a smaller bandwidth subchannel of a larger bandwidth channel. In operation according to RTS/CTS process 500a illustrated in FIG. 5A, the STA #1 (for example, a STA of STAs 104) transmits the RTS signal 510a to the AP (for example, AP 102). In this example, the AP is operating with one or more relatively large bandwidth channels (for example, 160 MHz bandwidth channel). Nevertheless, the STA #1 transmits the RTS signal 510a on a portion of the channel bandwidth (for example, 20 MHz bandwidth subchannel). In response to receiving the RTS signal 510a, the AP may operate to sense the channel bandwidth (for example, the full 160 MHz bandwidth) and, if determined to be clear (for example, CCA), transmit the CTS signal 520a allocating at least a portion of the channel bandwidth to the STA #1 for uplink communication.

In operation of the RTS/CTS process 500a, because the RTS was for a portion of the channel bandwidth, the CTS is correspondingly for the portion of the portion of the channel bandwidth. Continuing with the example in which the RTS signal 510a is on a 20 MHz bandwidth subchannel, the CTS signal 520a allocates the 20 MHz bandwidth subchannel to STA #1 for uplink communication in a TxOP. Continuing further with the example in which the AP is operating with a 160 MHz channel, the remaining 140 MHz (160 MHz−20 MHz=140 MHz) of the channel bandwidth remains unallocated for the TxOP. That is, irrespective of whether any or all of the remaining channel bandwidth is determined to be clear for the TxOP, this channel bandwidth other than the channel bandwidth corresponding to the RTS is unused for the TxOP. Thus, as illustrated in FIG. 5A, STA #1 transmits the uplink signal 530a in the portion of the channel bandwidth corresponding to the RTS signal 510a and no TxOP is provided for the other STAs (for example, other STAs of STAs 104).

In another example of facilitating communication within a wireless communication network, an AP may support a relatively large number of spatial streams. For example, the AP 102 may support a number of spatial streams with respect to a communication bandwidth in the range of 4 to 16. However, one or more of the STAs 104 in the BSS of the AP 102 may support a lesser number of spatial streams.

For example, a STA of the STAs 104 may support a number of spatial streams in the range of 1 to 3, where the number of spatial streams supported by the STA is less than the number of spatial streams supported by the AP 102. Such a STA may therefore utilize a smaller number of spatial streams than the AP is capable of supporting in any particular TxOP. For example, a STA of the STAs 104 having data for uplink transmission may transmit a RTS to the AP 102 for bandwidth (for example, all or some portion) of a communication bandwidth (for example, channel bandwidth) supported by the AP for allocation of a number of uplink streams as supported by the STA.

FIG. 5B shows a timing diagram illustrating an example RTS/CTS process 500b in which the RTS is made by a STA supporting fewer spatial streams than are supported by the AP. In operation according to RTS/CTS process 500b illustrated in FIG. 5B, the STA #1 (for example, a STA of STAs 104) transmits the RTS signal 510b to the AP (for example, AP 102). In this example, the AP supports a relatively large number of spatial streams (for example, 4 spatial streams). However, the STA #1 transmitting the RTS signal 510b supports a lesser number of spatial streams (for example, 2 spatial streams). In response to receiving the RTS signal 510b, the AP may operate to sense the communication bandwidth (for example, the full communication bandwidth). Additionally or alternatively, in response to receiving the RTS signal 510b, the AP may operate to detect, determine, or otherwise ascertain a number of spatial streams supported by the STA #1 (for example, determined from NSS capability information for the STA #1). The AP may, responsive to receiving the RTS signal 510a(for example, if the communication bandwidth is determined to be clear), thus transmit the CTS signal 520b allocating a number of spatial streams within at least a portion of the channel bandwidth to the STA #1 for uplink communication.

In operation of the RTS/CTS process 500b, because the RTS was from STA #1 supporting a number of spatial streams less than a number of spatial streams supported by the AP, the CTS is correspondingly for a number of spatial streams less than the number of spatial streams supported by the AP. Continuing with the example in which the STA #1 supports 2 spatial streams, the CTS signal 520b allocates 2 spatial streams to STA #1 for uplink communication in a TxOP. Continuing further with the example in which the AP supports 4 spatial streams, the remaining 2 spatial streams (4 spatial streams−2 spatial streams=2 spatial streams) remain unallocated for the TxOP. That is, irrespective of the AP having capability to support communication via any or all of the remaining spatial streams for the TxOP, the spatial streams other than the spatial streams corresponding to the number of spatial streams supported by the STA #1 are unused for the TxOP. Thus, as illustrated in FIG. 5B, STA #1 transmits the uplink signal 530b with 2 spatial streams no TxOP is provided for the other STAs (for example, other STAs of STAs 104).

Operation according to some aspects of the disclosure facilitates efficient utilization of available communication bandwidth. For example, available uplink channel bandwidth in addition to that corresponding to a subchannel bandwidth RTS may be utilized in a TxOP acquired in response to the subchannel bandwidth RTS. Operation according to some aspects of the disclosure additionally or alternatively facilitates efficient utilization of spatial streams available for use with respect to available communication bandwidth. For example, a number of spatial streams in addition to that corresponding to a number of spatial streams supported by a STA corresponding to a RTS may be utilized in a TxOP acquired in response to the RTS. In accordance with some examples, an AP (for example, AP 102) transmits a trigger signal (for example, a signal in accordance with the basic trigger frame 450 shown in FIG. 4) to multiple STAs (for example, STAs 104) if the communication channel is determined by the AP to be clear with respect to a TxOP acquired in association with a RTS.

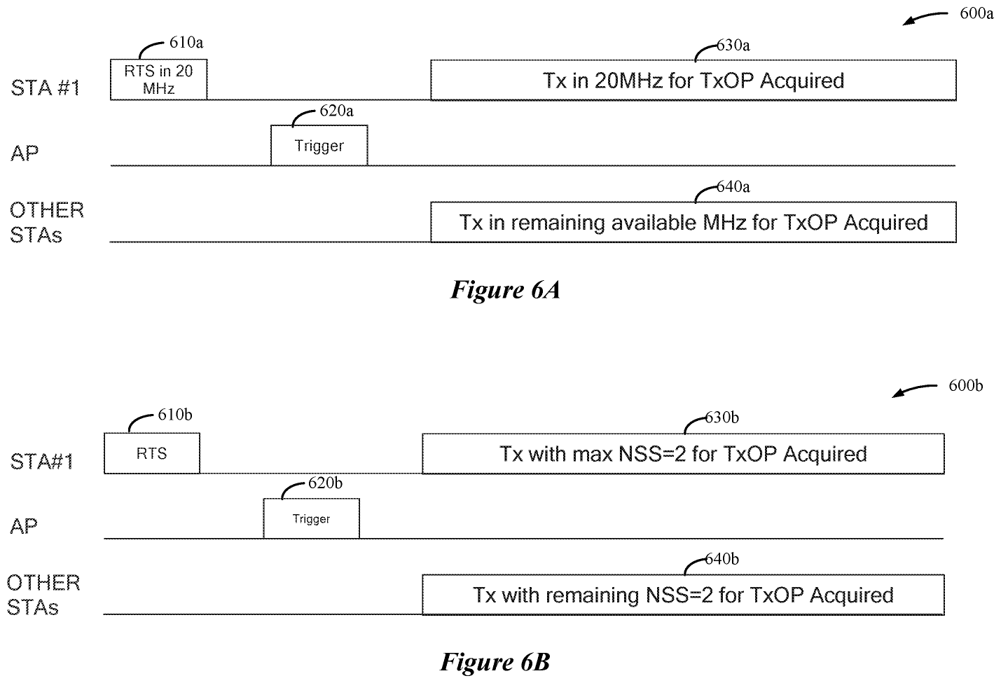

FIG. 6A shows a timing diagram illustrating an example RTS/trigger process 600a for utilizing available uplink channel bandwidth in response to a subchannel bandwidth request to send. In operation according to RTS/trigger process 600a illustrated in FIG. 6A, the STA #1 (for example, a STA of STAs 104) transmits the RTS signal 610a to the AP (for example, AP 102). In this example, the AP is operating with one or more relatively large bandwidth channels (for example, 160 MHz bandwidth channel). Nevertheless, the STA #1 transmits the RTS signal 610a on a portion of the channel bandwidth (for example, 20 MHz bandwidth subchannel). In response to receiving the RTS signal 610a, the AP may operate to sense the channel bandwidth (for example, the full 160 MHz bandwidth). According to some examples, if bandwidth of the channel bandwidth including the portion of the channel bandwidth of the RTS is determined to be clear (for example, CCA), the AP transmit the trigger signal 620a to the STA #1 and one or more other STAs (for example, one or more other STA of STAs 104). The trigger signal 620a may, for example, be transmitted instead of, rather than, or in place of a CTS signal (for example, the CTS signal 520a of FIG. 5A).

In operation of the RTS/trigger process 600a, despite the RTS being for a portion of the channel bandwidth, the trigger signal 620a allocates the portion of the channel bandwidth (for example, 20 MHz bandwidth subchannel) corresponding to the RTS signal 610a for uplink communication by the STA #1 and allocates one or more other portions of the channel bandwidth (for example, any or all subchannel bandwidths of the channel bandwidth determined to be clear) to one or more other STAs (for example, other STAs of STAs 104). Continuing with the example in which the RTS signal 610a is on a 20 MHz bandwidth subchannel, the trigger signal 620a allocates the 20 MHz bandwidth subchannel to STA #1 for uplink communication in a TxOP and may allocate all other bandwidth subchannels determined to be clear with respect to the TxOP other STAs. That is, any or all of the channel bandwidth that is determined to be clear for the TxOP may be used for the TxOP, despite the RTS being for only a portion of the channel bandwidth. Thus, as illustrated in FIG. 6A, STA #1 transmits the uplink signal 630a in the portion of the channel bandwidth corresponding to the RTS signal 610a and the other STAs may transmit uplink signals 640a in the other portions of the channel bandwidth determined to be clear for the TxOP. Continuing with the example in which the AP is operating with a 160 MHz channel, the remaining 140 MHz (160 MHz−20 MHz=140 MHz) of the channel bandwidth may be allocated for the TxOP where the full bandwidth of the channel bandwidth is determined by the AP to be clear.

FIG. 6B shows a timing diagram illustrating an example RTS/trigger process 600b for utilizing a number of spatial streams supported by an AP in response to a RTS from a STA supporting a lesser number of spatial streams. In operation according to RTS/trigger process 600b illustrated in FIG. 6B, the STA #1 (for example, a STA of STAs 104) transmits the RTS signal 610b to the AP (for example, AP 102). In this example, the AP supports a relatively large number of spatial streams (for example, 4 spatial streams). However, the STA #1 supports a lesser number of spatial streams (for example, 2 spatial streams). In response to receiving the RTS signal 610b, the AP may operate to sense the communication bandwidth (for example, channel bandwidth). Additionally or alternatively, in response to receiving the RTS signal 510b, the AP may operate to detect, determine, or otherwise ascertain a number of spatial streams supported by the STA #1 (for example, determined from NSS capability information for the STA #1). According to some examples (for example, if bandwidth of the channel bandwidth including the portion of the channel bandwidth of the RTS is determined to be clear), the AP transmits the trigger signal 620b to the STA #1 and one or more other STAs (for example, one or more other STA of STAs 104). The trigger signal 620b may, for example, be transmitted instead of, rather than, or in place of a CTS signal (for example, the CTS signal 520a of FIG. 5A).

In operation of the RTS/trigger process 600b, despite the STA #1 supporting a number of spatial streams less than a number of spatial streams supported by the AP, the trigger signal 620b allocates a number of spatial streams supported by the STA #1 (for example, the maximum number of spatial streams supported by the STA) for uplink communication by the STA #1 and allocates one or more additional spatial streams (for example, any or all remaining spatial streams as supported by the AP) to one or more other STAs (for example, other STAs of STAs 104). Continuing with the example in which the STA #1 supports 2 spatial streams, the trigger signal 620b allocates up to 2 spatial streams to the STA #1 for uplink communication in a TxOP and may allocate all other spatial streams supported by the AP to other STAs for the TxOP. That is, any or all of the number of spatial streams supported by the AP may be used for the TxOP, despite the STA #1 supporting only a portion of that number of spatial streams. Thus, as illustrated in FIG. 6B, STA #1 transmits the uplink signal 630b via a number of spatial streams supported by the STA #1 and the other STAs may transmit uplink signals 640b via additional spatial streams as supported by the AP. Continuing with the example in which the AP is supports 4 spatial streams and the STA #1 supports 2 spatial streams, the remaining 2 spatial streams (4 spatial streams−2 spatial streams=2 spatial streams) supported by the AP may be allocated for the TxOP.

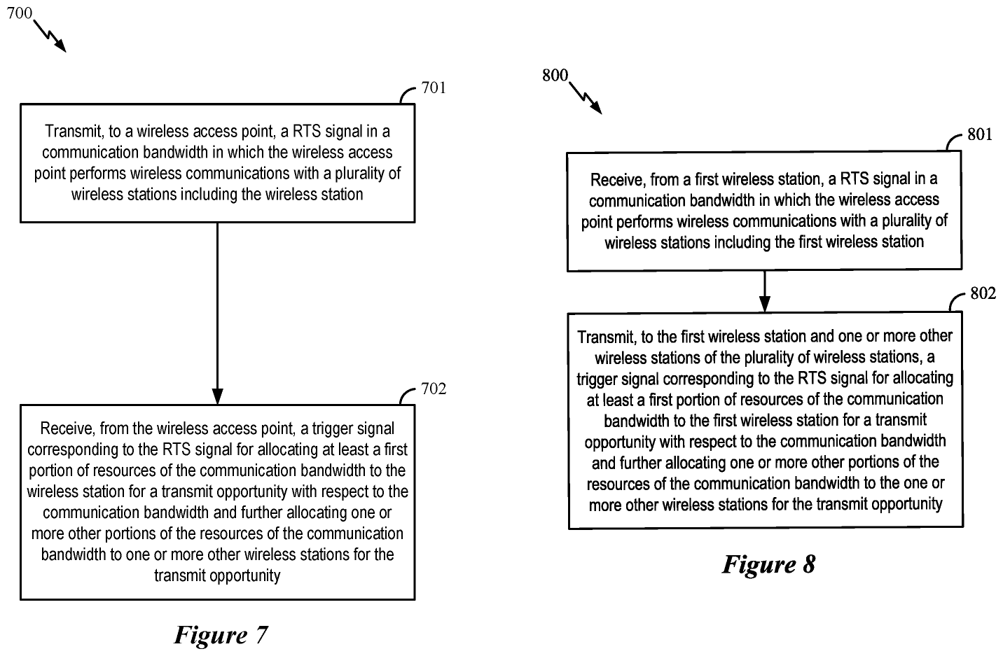

FIG. 7 shows a flowchart illustrating an example process 700 performable by or at a wireless STA that supports operation providing a trigger signal in response to a request to send. Operation according to the process 700 of some examples facilitates utilization of available uplink channel bandwidth in response to a subchannel bandwidth request to send. Additionally or alternatively, operation according to the process 700 of some examples facilitates utilization of a number of spatial streams in excess to a number of spatial streams supported by a wireless STA making a request to send.

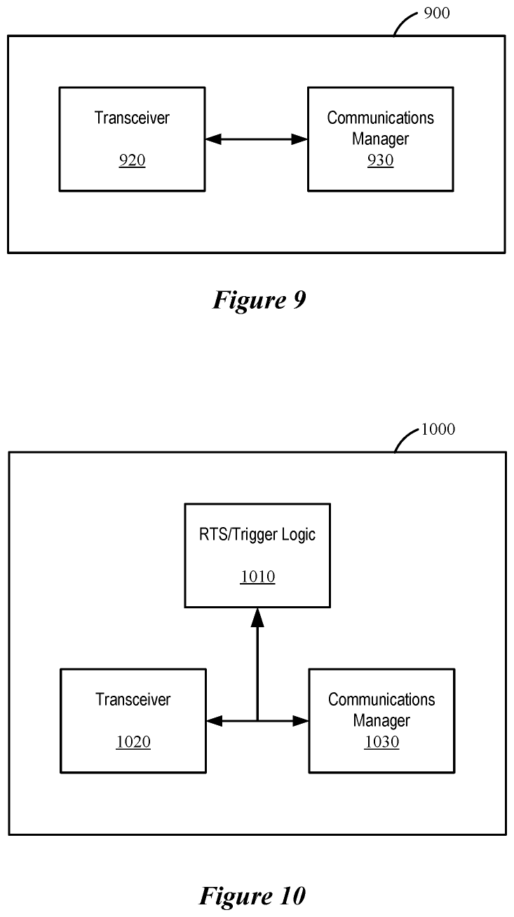

The process 700 illustrates an example of a RTS/trigger procedure performed by or at a wireless STA for operation in which a trigger signal is provided in response to a request to send. The operations of the process 700 may be implemented by a wireless STA or its components as described herein. For example, the process 700 may be performed by a wireless communication device, such as the wireless communication device 900 described with reference to FIG. 9, operating as or within a wireless STA. In some examples, the process 700 may be performed by a wireless STA such as one of the STAs 104 described with reference to FIG. 1.

In some examples, in block 701, the wireless STA may transmit, to a wireless AP, a RTS signal in a communication bandwidth in which the wireless AP performs wireless communications with a plurality of wireless STAs including the wireless STA. For example, a first STA of the STAs 104 shown in FIG. 1 may transmit (for example, using one or more transceiver Tx/Rx chains under control of a communication manager of the first STA) the RTS signal 610a shown in FIG. 6A or the RTS signal 610b shown in FIG. 6B to the AP 102.

According to some aspects, the RTS signal may be transmitted in a first portion of the communication bandwidth. The first portion of the communication bandwidth may, for example, include less bandwidth than is currently available from a prospective of the wireless AP for a transmit opportunity with respect to the communication bandwidth. According to some examples, the first portion of the communication bandwidth may include subset or sub-band of the communication bandwidth that is currently available from a prospective of the wireless STA for a transmit opportunity with respect to the communication bandwidth. For example, the wireless STA may perform sensing (for example, perform CCA operation, such as under control of a communications manager of the wireless STA) with respect to the communication bandwidth or otherwise determine that the first portion of the communication bandwidth is clear and available (for example, the first portion of the communication bandwidth meet criteria for communication availability) for a transmit opportunity with respect to the communication bandwidth for the wireless STA. The wireless STA may, for example, observe that its secondary CCA is busy at a particular point when the wireless STA has data for uplink transmission, the wireless STA may transmit at a reduced bandwidth for reliable communications when disposed relatively far from the wireless AP, etc., and may transmit a RTS for all or some portion of the communication bandwidth the wireless station senses as currently available. The wireless AP of some examples may nevertheless perform sensing with respect to the communication bandwidth or otherwise determine that bandwidth in addition to the first portion of the communication bandwidth is available for a transmit opportunity with respect to the communication bandwidth for a plurality of wireless STAs. According to some examples, the communication bandwidth may be or include a first channel, the first portion of the communication bandwidth may be or include a first subchannel within the first channel, and the bandwidth in addition to the first portion of the communication bandwidth may be or include one or more other subchannels of the first channel.

In block 702 of the example of FIG. 7, the wireless STA may receive, from the wireless AP, a trigger signal corresponding to the RTS signal for allocating at least a first portion of resources of the communication bandwidth to the wireless STA for a transmit opportunity with respect to the communication bandwidth and further allocating one or more other portions of the resources of the communication bandwidth to one or more other wireless STAs for the transmit opportunity. For example, the first wireless STA of the STAs 104 shown in FIG. 1 may receive (for example, using one or more transceiver Tx/Rx chains under control of a communication manager of the first wireless STA) the trigger signal 620a shown in FIG. 6A or the trigger signal 620b shown in FIG. 6B from the AP 102. According to some examples, the first portion of the resources of the communication bandwidth and the one or more other portions of the resources of the communication bandwidth include bandwidth portions (for example, one or more portions of contiguous spectrum, portions of non-contiguous spectrum, or combinations thereof) of the communication bandwidth that meets criteria for communication availability prior to receiving the trigger signal. Additionally or alternatively, according to some examples, the at least a first portion of the resources of the communication bandwidth and the one or more other portions of the resources of the communication bandwidth may include spatial streams (for example, independent spatial streams which are separately encoded and transmitted in parallel) in the communication bandwidth which are available for use in the transmit opportunity.

The trigger signal of some examples is configured to solicit the wireless STA and the one or more other wireless STAs into transmitting via respective allocated portions of the resources of the communication bandwidth during the transmit opportunity. For example, the trigger signal may be in accordance with the basic trigger frame 450 shown in FIG. 4, such as may be utilized by the AP 102 to solicit uplink transmissions by the STAs 104.

The wireless STA, having received the trigger signal allocating the at least a first portion of the resources of the communication bandwidth to the wireless STA, may operate to transmit an uplink signal to the wireless AP during the transmit opportunity using the first portion of the resources of the communication bandwidth allocated to the wireless STA. Likewise, the one or more other wireless STAs, having received the trigger signal further allocating one or more other portions of the resources of the communication bandwidth to the one or more other wireless STAs for the transmit opportunity, may operate to transmit one or more uplink signals to the wireless AP during the transmit opportunity using the one or more other portions of the resources of the communication bandwidth. According to some examples, the wireless STA may transmit the uplink signal 630a shown in FIG. 6A or the uplink signal 630b shown in FIG. 6B in the first portion of the resources of the communication bandwidth during the transmit opportunity and the one or more other wireless STAs may transmit the uplink signals 640a or 640b in the one or more other portions of the resources of the communication bandwidth during the transmit opportunity.

In operation according to some examples in which the first portion of the resources of the communication bandwidth and the one or more other portions of the resources of the communication bandwidth include bandwidth portions of the communication bandwidth, the wireless STA may transmit (for example, using one or more transceiver Tx/Rx chains under control of a communication manager of the first wireless STA) a portion of a MU TB-PPDU to the wireless AP using the first portion of the resources of the communication bandwidth. Correspondingly, the one or more other wireless STAs may transmit one or more respective portions of the MU TB-PPDU to the wireless AP using the one or more other portions of the resources of the communication bandwidth. The MU TB PPDU may, for example, be in accordance with PPDU 300 shown in FIG. 3. According to some examples, the MU TB-PPDU may utilize a full bandwidth of the communication bandwidth. According to other examples, the MU TB-PPDU may utilize all bandwidth of the communication bandwidth available for the transmit opportunity (for example, all of the communication bandwidth determined to be clear and available for the transmit opportunity, but less than the full communication bandwidth).

In operation according to some examples in which the first portion of the resources of the communication bandwidth and the one or more other portions of the resources of the communication bandwidth include spatial streams in the communication bandwidth, the wireless STA may transmit (for example, using one or more transceiver Tx/Rx chains under control of a communication manager of the first wireless STA) a portion of an UL MU-MIMO signal to the wireless AP using spatial streams of the first portion of the resources of the communication bandwidth. Correspondingly, the one or more other wireless STAs may transmit one or more respective portions of the UL MU-MIMO signal to the wireless AP using the one or more other portions of the resources of the communication bandwidth. According to some examples, the UL MU-MIMO signal may utilize a full bandwidth of the communication bandwidth. According to other examples, the UL MU-MIMO signal may utilize all bandwidth of the communication bandwidth available for the transmit opportunity (for example, all of the communication bandwidth determined to be clear and available for the transmit opportunity, but less than the full communication bandwidth).

FIG. 8 shows a flowchart illustrating an example process 800 performable by or at a wireless AP that supports operation providing a trigger signal in response to a request to send. Operation according to the process 800 of some examples facilitates utilization of available uplink channel bandwidth in response to a subchannel bandwidth request to send. Additionally or alternatively, operation according to the process 800 of some examples facilitates utilization of a number of spatial streams in excess to a number of spatial streams supported by a wireless STA making a request to send.

The process 800 illustrates an example of a RTS/trigger procedure performed by or at a wireless AP for providing a trigger signal in response to a request to send. The operations of the process 800 may be implemented by a wireless AP or its components as described herein. For example, the process 800 may be performed by a wireless communication device, such as the wireless communication device 1000 described with reference to FIG. 10, operating as or within a wireless AP. In some examples, the process 800 may be performed by a wireless AP such as the AP 102 described with reference to FIG. 1.

In some examples, in block 801, the wireless AP may receive, from a first wireless STA, a RTS signal in a communication bandwidth in which the wireless AP performs wireless communications with a plurality of wireless STAs including the first wireless STA. For example, the AP 102 shown in FIG. 1 may receive (for example, using one or more transceiver Tx/Rx chains under control of a communication manager of the AP) the RTS signal 610a shown in FIG. 6A or the RTS signal 610b shown in FIG. 6B from a first STA of the STAs 104.

According to some aspects, the RTS signal may be received in a first portion of the communication bandwidth. The first portion of the communication bandwidth may, for example, include less bandwidth than is currently available from a prospective of the wireless AP for a transmit opportunity with respect to the communication bandwidth. According to some examples, the first portion of the communication bandwidth may include a subset or sub-band of the communication bandwidth that is currently available from a prospective of the wireless STA for a transmit opportunity with respect to the communication bandwidth.

The wireless AP of some examples may perform sensing with respect to the communication bandwidth or otherwise determine that bandwidth including the first portion of the communication bandwidth and bandwidth in addition to the first portion of the communication bandwidth is available for a transmit opportunity with respect to the communication bandwidth for the plurality of wireless STAs. For example, the wireless AP may sense (for example, perform CCA operation, such as under control of a communications manager of the wireless AP) that the first portion of the communication bandwidth and the one or more other portions of the communication bandwidth are clear and available (for example, the portions of the communication bandwidth meet criteria for communication availability) for a transmit opportunity with respect to the communication bandwidth for the first wireless STA and one or more other wireless STAs. According to some examples, the communication bandwidth may be or include a first channel, the first portion of the communication bandwidth may be or include a first subchannel within the first channel, and the one or more other portions of the communication bandwidth may be or include one or more other subchannels of the first channel.

According to some examples, the wireless AP, having sensed or otherwise determined that resources of the communication bandwidth in addition to resources to be allocated to the wireless STA in correspondence with the RTS are available for the transmit opportunity, may elect to omit or otherwise forego transmission of a CTS signal in response to the RTS signal. The wireless AP may, instead of transmitting a CTS signal corresponding to the RTS signal, transmit a trigger signal corresponding to the RTS signal.

The wireless AP of some examples may operate to detect, determine, or otherwise ascertain that bandwidth of the first portion of the resources of the communication bandwidth to be allocated to the wireless STA and bandwidth in addition to the first portion of the resources of the communication bandwidth is available for a transmit opportunity with respect to the communication bandwidth for the plurality of wireless STAs. Accordingly, the wireless AP may elect to omit or otherwise forego transmission of a CTS signal allocating only the bandwidth of the first portion of the resources of the communication bandwidth for the transmit opportunity in response to the RTS signal and instead transmit a trigger signal allocating the bandwidth of the first portion of the resources of the communication bandwidth to the wireless station and further allocating bandwidth of one or more other portions of the resources of the communication bandwidth to one or more other wireless STAs for the transmit opportunity. For example, the wireless AP may analyze (for example, under control of RTS/trigger logic implemented by the wireless AP) bandwidth of the communication bandwidth that is available for a transmit opportunity with respect to the plurality of wireless STAs and determine to omit or otherwise forego transmission of a CTS signal in response to the RTS signal, such as in situations where bandwidth of the communication bandwidth in addition to a first portion of the communication bandwidth to be allocated to the wireless STA is clear and available for uplink communication in the transmit opportunity.

The wireless AP of some examples may additionally or alternatively operate to detect, determine, or otherwise ascertain that spatial streams of the first portion of the resources of the communication bandwidth to be allocated to the wireless STA and spatial streams in addition to the first portion of the resources of the communication bandwidth are available for a transmit opportunity with respect to the communication bandwidth for the plurality of wireless STAs. Accordingly, the wireless AP may elect to omit or otherwise forego transmission of a CTS signal allocating only the spatial streams of the first portion of the resources of the communication bandwidth for the transmit opportunity in response to the RTS signal and instead transmit a trigger signal allocating the spatial streams of the first portion of the resources of the communication bandwidth to the wireless station and further allocating spatial streams of one or more other portions of the resources of the communication bandwidth to one or more other wireless STAs for the transmit opportunity. For example, the wireless AP may analyze (for example, under control of RTS/trigger logic implemented by the wireless AP) spatial stream capability information for the wireless STA and determine that a number of spatial streams in excess to the maximum number of spatial streams supported by the wireless STA are available for a transmit opportunity with respect to the plurality of wireless STAs. The wireless AP may therefore determine to omit or otherwise forego transmission of a CTS signal in response to the RTS signal, such as in situations where spatial streams in the communication bandwidth in addition to the spatial streams to be allocated to the wireless STAT are available for uplink communication in the transmit opportunity.

In accordance with operation of a RTS/trigger procedure of some examples, the wireless AP may configure (for example, under control of RTS/trigger logic implemented by the wireless AP) a trigger signal for transmission in correspondence with the RTS signal instead of, rather than, or in place of transmitting a CTS signal to the wireless STA. The trigger signal of some examples is configured to solicit the first wireless STA and one or more other wireless STAs into transmitting via respective allocated portions of the resources of the communication bandwidth during the transmit opportunity. The trigger signal may, for example, be configured as a trigger frame (for example, basic trigger frame 450 shown in FIG. 4) addressing the first wireless STA and the one or more other wireless STAs through respective AIDs, and assigning each AID, and thus each respective STA, one or more RUs that can be used to send UL traffic to the wireless AP. For example, the wireless AP may configure (for example, under control of RTS/trigger logic implemented by the wireless AP) the trigger signal for transmission to multiple wireless STAs for facilitating use of clear bandwidth of the communication channel in addition to that of the first portion of the communication bandwidth of the RTS. The wireless AP may additionally or alternatively configure the trigger signal for transmission to multiple wireless STAs for facilitating use of available spatial streams in the communication channel in addition to that of the first portion of spatial streams in the communication bandwidth supported by the wireless station having transmitted the RTS.

In block 802 of the example of FIG. 8, the wireless AP may transmit, to the first wireless STA and one or more other wireless STAs, a trigger signal corresponding to the RTS signal for allocating at least a first portion of the resources of the communication bandwidth to the wireless STA for the transmit opportunity and further allocating one or more other portions of the resources of the communication bandwidth to one or more other wireless STAs for the transmit opportunity. For example, the wireless AP 102 shown in FIG. 1 may transmit (for example, using one or more transceiver Tx/Rx chains under control of a communication manager of the wireless AP) the trigger signal 620a shown in FIG. 6A or the trigger signal 620b shown in FIG. 6B to the first wireless STA of STAs 104 and to one or more other wireless STAs of STAs 104. According to some examples, the first portion of the resources of the communication bandwidth and the one or more other portions of the resources of the communication bandwidth include bandwidth portions (for example, one or more portions of contiguous spectrum, portions of non-contiguous spectrum, or combinations thereof) of the communication bandwidth that meets criteria for communication availability prior to transmitting the trigger signal. Additionally or alternatively, according to some examples, the at least a first portion of the resources of the communication bandwidth and the one or more other portions of the resources of the communication bandwidth may include spatial streams (for example, independent spatial streams which are separately encoded and transmitted in parallel) in the communication bandwidth which are available for use in the transmit opportunity.

The wireless AP, having transmitted the trigger signal allocating the first portion of the resources of the communication bandwidth to the first wireless STA and one or more other portions of the resources of the communication bandwidth to the one or more other wireless STAs, may operate to receive (for example, using one or more transceiver Tx/Rx chains under control of a communication manager of the wireless AP) one or more uplink signals from the wireless STAs during the transmit opportunity using the first portion of the resources of the communication bandwidth and the one or more other portions of the resources of the communication bandwidth. According to some examples, the wireless AP may receive the uplink signal 630a shown in FIG. 6A or the uplink signal 630b shown in FIG. 6B in the first portion of the resources of the communication bandwidth and the uplink signals 640 in the one or more other portions of the resources of the communication bandwidth during the transmit opportunity.

In operation according to some examples in which the first portion of the resources of the communication bandwidth and the one or more other portions of the resources of the communication bandwidth include bandwidth portions of the communication bandwidth, the wireless AP may receive (for example, using one or more transceiver Tx/Rx chains under control of a communication manager of the wireless AP) a MU TB-PPDU in the transmit opportunity. The MU TB-PPDU may include a portion associated with the first wireless STA received by the wireless AP using bandwidth of the first portion of the resources of the communication bandwidth and one or more other portions associated with the one or more other wireless STAs received by the wireless AP using bandwidth of the one or more other portions of the resources of the communication bandwidth. The MU TB PPDU may, for example, be in accordance with PPDU 300 shown in FIG. 3. According to some examples, the MU TB-PPDU may utilize a full bandwidth of the communication bandwidth. According to other examples, the MU TB-PPDU may utilize all bandwidth of the communication bandwidth available for the transmit opportunity (for example, all of the communication bandwidth determined to be clear and available for the transmit opportunity, but less than the full communication bandwidth).

In operation according to some examples in which the first portion of the resources of the communication bandwidth and the one or more other portions of the resources of the communication bandwidth include spatial streams in the communication bandwidth, the wireless AP may receive (for example, using one or more transceiver Tx/Rx chains under control of a communication manager of the wireless AP) an UL MU-MIMO signal in the transmit opportunity. The UL MU-MIMO signal may include a portion associated with the first wireless STA received by the wireless AP using spatial streams of the first portion of the resources of the communication bandwidth and one or more other portions associated with the one or more other wireless STAs received by the wireless AP using spatial streams of the one or more other portions of the resources of the communication bandwidth. According to some examples, the UL MU-MIMO signal may utilize a full bandwidth of the communication bandwidth. According to other examples, the UL MU-MIMO signal may utilize all bandwidth of the communication bandwidth available for the transmit opportunity (for example, all of the communication bandwidth determined to be clear and available for the transmit opportunity, but less than the full communication bandwidth).

The communication bandwidth of some examples, such as examples described above with reference to FIGS. 7 and 8, may be or include a first channel, the first portion of the communication bandwidth may be or include a first subchannel within the first channel, and the one or more other portions of the communication bandwidth may be or include one or more other subchannels of the first channel. For example, the communication bandwidth may a first channel of relatively large bandwidth channel (for example, 80 MHz, 160 MHz, 240 MHz, 320 MHz, 480 MHz, or 640 MHz bandwidth primary channel) with respect to the first subchannel (for example, 20 MHz or 40 MHz bandwidth subchannel) of the first portion of the communication bandwidth. The one or more other subchannels of the one or more other portions of the communication bandwidth may include the subchannels of the communication bandwidth determined to be clear and available for the transmit opportunity in addition to the first subchannel. In an example, the first subchannel and the one or more other subchannels may span a full bandwidth of the first channel. In another example, the one or more other subchannels may correspond to bandwidth of the first channel available for the transmit opportunity, where the first subchannel and the one or more other subchannels span less than a full bandwidth of the first channel.

The communication bandwidth of some examples, such as examples described above with reference to FIGS. 7 and 8, may be or include a plurality of spatial streams. For example, the wireless AP may support multiple simultaneous streams (for example, up to 16 data streams) in the communication bandwidth. One or more wireless STAs in communication with the wireless AP also may support multiple simultaneous streams (for example, up to 4 data streams) in the communication bandwidth. The communication bandwidth may, according to some examples, include a first number of streams transmitted in the uplink by a first wireless STA and a second number of streams transmitted in the uplink by one or more other wireless STAs, where the first number of streams and the second number of streams sum to be a third number of streams equal to or less than a number of streams supported by the wireless AP.

FIG. 9 shows a block diagram of an example wireless communication device 900 that supports operation providing a trigger signal in response to a request to send. In some examples, the wireless communication device 900 is configured to perform the process 700 described with reference to FIG. 7. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random- access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes a transceiver component 920 and a communications manager component 930. Portions of one or more of the components 920 and 930 may be implemented at least in part in hardware or firmware. For example, the transceiver component 920 may be implemented at least in part by a modem. In some examples, portions of one or more of the components 920 and 930 may be implemented at least in part by a processor and software in the form of processor-executable code stored in the memory.

The transceiver component 920 and the communications manager component 930 of some examples are configurable or configured to perform, manage, and/or control various functionality for utilizing available uplink channel bandwidth in response to a subchannel bandwidth request to send. Additionally or alternatively, the transceiver component 920 and the communications manager component 930 of some examples are configurable or configured to perform, manage, and/or control various functionality for utilization of a number of spatial streams supported by an AP in response to a RTS from the wireless communication device supporting a lesser number of spatial streams. According to some examples, the transceiver component 920 and the communications manager component 930 include circuitry and logic configured to perform, manage, and/or control one or more functions of the process 700 of FIG. 7. Although shown separately in the example of FIG. 9, some portion or all of the transceiver component 920, the communications manager component 930, or any combination thereof may be included as part of another component of the wireless communication device 900 (for example, one or more of the transceiver component 920 or the communications manager component 930).

The transceiver component 920 of some examples is configurable or configured to sense at least some portion of a communication bandwidth, such as for performing CCA operation. The transceiver component 920 of some examples is configurable or configured to transmit spatial stream capability information to a wireless AP. The transceiver component 920 of some examples is, additionally or alternatively, configurable or configured to transmit a RTS signal, such as in a first portion of the resources of a communication bandwidth in which a wireless AP performs wireless communications with a plurality of wireless communication devices including the wireless communication device 900. Additionally or alternatively, the transceiver component 920 of some examples is configurable or configured to receive a trigger signal, such as a trigger signal corresponding to the RTS signal for allocating the first portion of the resources of the communication bandwidth to the wireless communication device 900 for the transmit opportunity and further allocating one or more other portions of the communication bandwidth to one or more other wireless communication devices for the transmit opportunity. The transceiver component 920 of some examples is, additionally or alternatively, configurable or configured to transmit a portion of a MU TB-PPDU, such as in response to the trigger signal. Additionally or alternatively, the transceiver component 920 of some examples is configurable or configured to transmit a portion of a UL MU-MIMO signal, such as in response to the trigger signal. According to some examples, the transceiver component 920 is configured or configurable to perform one or more of the above functions under control or management, or otherwise in cooperation with, the communications manager component 930.

The communications manager component 930 of some examples is configurable or configured to initiate, control, manage, and/or perform sensing at least some portion of a communication bandwidth, such as for performing CCA operation. The communications manager component 930 of some examples is configurable or configured to initiate, control, manage, and/or perform transmission of spatial stream capability information to a wireless AP. The communications manager component 930 of some examples is, additionally or alternatively, configurable or configured to initiate, control, manage, and/or perform transmission of a RTS signal, such as in a first portion of the resources of a communication bandwidth in which a wireless AP performs wireless communications with a plurality of wireless communication devices including the wireless communication device 900. Additionally or alternatively, the communications manager component 930 of some examples is configurable or configured to initiate, control, manage, and/or perform receiving a trigger signal, such as a trigger signal corresponding to the RTS signal for allocating the first portion of the resources of the communication bandwidth to the wireless communication device 900 for the transmit opportunity and further allocating one or more other portions of the resources of the communication bandwidth to one or more other wireless communication devices for the transmit opportunity. The communications manager component 930 of some examples is, additionally or alternatively, configurable or configured to initiate, control, manage, and/or perform transmission of a portion of a MU TB-PPDU, such as in response to the trigger signal. Additionally or alternatively, the communications manager component 930 of some examples is configurable or configured to initiate, control, manage, and/or perform transmission of a portion of a UL MU-MIMO signal, such as in response to the trigger signal. According to some examples, the communications manager component 930 is configured or configurable to initiate, control, and/or manage operation of the transceiver component 920 with respect to performing one or more of the above functions.

In certain aspects, the transceiver component 920 and the communications manager component 930 include circuitry (as an example of means for) operative cooperatively for transmitting a RTS signal, such as in a first portion of the resources of a communication bandwidth in which a wireless AP performs wireless communications with a plurality of wireless communication devices including the wireless communication device 900. In certain aspects, the transceiver component 920 and the communications manager component 930 additionally or alternatively include circuitry (as an example of means for) operative cooperatively for receiving a trigger signal corresponding to the RTS signal for allocating the first portion of the resources of the communication bandwidth to the wireless communication device 900 for the transmit opportunity and further allocating one or more other portions of the resources of the communication bandwidth to one or more other wireless communication devices for the transmit opportunity. In certain aspects, the transceiver component 920 and the communications manager component 930 additionally or alternatively include circuitry (as an example of means for) operative cooperatively for transmitting a portion of a MU TB-PPDU. In certain aspects, the transceiver component 920 and the communications manager component 930 additionally or alternatively include circuitry (as an example of means for) operative cooperatively for transmitting a portion of a UL MU-MIMO signal.

FIG. 10 shows a block diagram of an example wireless communication device 1000 that supports operation providing a trigger signal in response to a request to send. In some examples, the wireless communication device 1000 is configured to perform the process 800 described with reference to FIG. 8. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a RTS/trigger logic component 1010, a transceiver component 1020, and a communications manager component 1030. Portions of one or more of the components 1010, 1020, and 1030 may be implemented at least in part in hardware or firmware. For example, the transceiver component 1020 may be implemented at least in part by a modem. In some examples, portions of one or more of the components 1010, 1020, and 1030 may be implemented at least in part by a processor and software in the form of processor- executable code stored in a memory.

The RTS/trigger logic component 1010, the transceiver component 1020, and the communications manager component 1030 of some examples are configurable or configured to perform, manage, and/or control various functionality for utilizing available uplink channel bandwidth in response to a subchannel bandwidth request to send. Additionally or alternatively, the RTS/trigger logic component 1010, the transceiver component 1020, and the communications manager component 1030 of some examples are configurable or configured to perform, manage, and/or control various functionality for utilizing a number of spatial streams supported by the wireless communication device in response to a RTS from a wireless STA supporting a lesser number of spatial streams. According to some examples, the RTS/trigger logic component 1010, the transceiver component 1020, and the communications manager component 1030 include circuitry and logic configured to perform, manage, and/or control one or more functions of the process 800 of FIG. 8. Although shown separately in the example of FIG. 10, some portion or all of the RTS/trigger logic component 1010, the transceiver component 1020, the communications manager component 1030, or any combination thereof may be included as part of another component of the wireless communication device 1000 (for example, one or more of the RTS/trigger logic component 1010, the transceiver component 1020, or the communications manager component 1030).

The RTS/trigger logic component 1010 of some examples is configurable or configured to initiate, control, manage, and/or perform receiving a RTS signal, such as in a first portion of the resources of a communication bandwidth in which the wireless communication device 1000 performs wireless communications with a plurality of wireless communication devices. The RTS/trigger logic component 1010 of some examples is configurable or configured to initiate, control, manage, and/or perform receiving spatial stream capability information from one or more wireless STAs. The RTS/trigger logic component 1010 of some examples is, additionally or alternatively, configurable or configured to initiate, control, manage, and/or perform sensing some or all portions of a communication bandwidth, such as for initiating CCA operation in response to or otherwise in correspondence with a RTS for a first portion of the resources of a communication bandwidth in which the wireless communication device 1000 performs wireless communications with a plurality of wireless communication devices. Additionally or alternatively, the RTS/trigger logic component 1010 of some examples is configurable or configured to initiate, control, manage, and/or perform analysis of bandwidth of the communication bandwidth that is available for a transmit opportunity with respect to the wireless communication devices, such as for determining whether to omit or otherwise forego transmission of a CTS signal in response to the RTS signal. The RTS/trigger logic component 1010 of some examples is configurable or configured to initiate, control, manage, and/or perform analysis spatial stream capability information with respect to one or more wireless STAs, such as for determining whether to omit or otherwise forego transmission of a CTS signal in response to the RTS signal. The RTS/trigger logic component 1010 of some examples is, additionally or alternatively, configurable or configured to initiate, control, manage, and/or perform configuring a trigger signal, such as for transmission in correspondence with the RTS signal instead of, rather than, or in place of transmitting a CTS signal to the wireless communication device that transmitted the RTS signal. Additionally or alternatively, the RTS/trigger logic component 1010 of some examples is configurable or configured to initiate, control, manage, and/or perform transmission of a trigger signal, such as a trigger signal corresponding to the RTS signal for allocating the first portion of the resources of the communication bandwidth to a first wireless communication device for the transmit opportunity and further allocating one or more other portions of the resources of the communication bandwidth to the one or more other wireless communication devices for the transmit opportunity. The RTS/trigger logic component 1010 of some examples is configurable or configured to initiate, control, manage, and/or perform receiving a MU TB-PPDU, such as may be transmitted in response to the trigger signal. The RTS/trigger logic component 1010 of some examples is configurable or configured to initiate, control, manage, and/or perform receiving a UL MU-MIMO signal, such as may be transmitted in response to the trigger signal.

The transceiver component 1020 of some examples is configurable or configured to receive a RTS signal, such as in a first portion of the resources of a communication bandwidth in which the wireless communication device 1000 performs wireless communications with a plurality of wireless communication devices. The transceiver component 1020 of some examples is configurable r configured to receive spatial stream capability information from one or more wireless STAs. The transceiver component 1020 of some examples is, additionally or alternatively, configurable or configured to sense some or all portions of a communication bandwidth, such as for performing CCA operation. Additionally or alternatively, the transceiver component 1020 of some examples is configurable or configured to transmit a trigger signal, such as a trigger signal corresponding to the RTS signal for allocating the first portion of the resources of the communication bandwidth to wireless communication device for the transmit opportunity and further allocating one or more other portions of the resources of the communication bandwidth to one or more other wireless communication devices for the transmit opportunity. The transceiver component 1020 of some examples is, additionally or alternatively, configurable or configured to receive a MU TB-PPDU, such as in response to the trigger signal. Additionally or alternatively, the transceiver component 1020 of some examples is configurable or configured to receive a UL MU- MIMO signal, such as in response to the trigger signal According to some examples, the transceiver component 1020 is configured or configurable to perform one or more of the above functions under control or management, or otherwise in cooperation with, the RTS/trigger logic component 1010, the communications manager component 1030, or a combination thereof.

The communications manager component 1030 of some examples is configurable or configured to initiate, control, manage, and/or perform receiving a RTS signal, such as in a first portion of the resources of a communication bandwidth in which the wireless communication device 1000 performs wireless communications with a plurality of wireless communication devices. The communications manager component 1030 of some examples is, additionally or alternatively, configurable or configured to initiate, control, manage, and/or perform sensing some or all portions of a communication bandwidth, such as for performing CCA operation. Additionally or alternatively, the communications manager component 1030 of some examples is configurable or configured to initiate, control, manage, and/or perform transmission of a trigger signal, such as a trigger signal corresponding to the RTS signal for allocating the first portion of the resources of the communication bandwidth to a wireless communication device for the transmit opportunity and further allocating one or more other portions of the resources of the communication bandwidth to one or more other wireless communication devices for the transmit opportunity. The communications manager component 1030 of some examples is, additionally or alternatively, configurable or configured to initiate, control, manage, and/or perform receiving a MU TB-PPDU, such as may be transmitted in response to the trigger signal. Additionally or alternatively, the communications manager component 1030 of some examples is configurable to configured to initiate, control, manage, and/or perform receiving a UL MU-MIMO signal, such as may be transmitted in response to the trigger signal. According to some examples, the communications manager component 1030 is configured or configurable to initiate, control, and/or manage operation of the transceiver component 1020 with respect to performing one or more of the above functions, such as in cooperation with RTS/trigger logic component 1010.

In certain aspects, the RTS/trigger logic component 1010, the transceiver component 1020, and the communications manager component 1030 include circuitry (as an example of means for) operative cooperatively for receiving a RTS signal, such as in a first portion of the resources of a communication bandwidth in which the wireless communication device performs wireless communications with a plurality of wireless communication devices. In certain aspects, the RTS/trigger logic component 1010, the transceiver component 920, and the communications manager component 930 additionally or alternatively include circuitry (as an example of means for) operative cooperatively for sensing that the first portion of the resources of the communication bandwidth and the one or more other portions of the resources of the communication bandwidth meet criteria for communication availability. In certain aspects, the RTS/trigger logic component 1010, the transceiver component 920, and the communications manager component 930 additionally or alternatively include circuitry (as an example of means for) operative cooperatively for transmitting a trigger signal corresponding to the RTS signal for allocating the first portion of the resources of the communication bandwidth to a wireless communication device for the transmit opportunity and further allocating one or more other portions of the resources of the communication bandwidth to one or more other wireless communication devices for the transmit opportunity. In certain aspects, the RTS/trigger logic component 1010, the transceiver component 1020, and the communications manager component 1030 additionally or alternatively include circuitry (as an example of means for) operative cooperatively for receiving a MU TB-PPDU. In certain aspects, the RTS/trigger logic component 1010, the transceiver component 1020, and the communications manager component 1030 additionally or alternatively include circuitry (as an example of means for) operative cooperatively for receiving a UL MU-MIMO signal.

Implementation examples are described in the following numbered clauses:

Clause 1. A method for wireless communication by a wireless access point may provide for receiving, from a first wireless station, a RTS signal in a first portion of a communication bandwidth in which the wireless access point performs wireless communications with a plurality of wireless stations including the first wireless station, and transmitting, to the first wireless station and one or more other wireless stations of the plurality of wireless stations, a trigger signal corresponding to the RTS signal for allocating at least a first portion of resources of the communication bandwidth to the first wireless station for a transmit opportunity with respect to the communication bandwidth and further allocating one or more other portions of the resources of the communication bandwidth to the one or more other wireless stations for the transmit opportunity.

Clause 2. The method of clause 1, may provide for sensing that the first portion of the resources of the communication bandwidth and the one or more other portions of the resources of the communication bandwidth meet criteria for communication availability.

Clause 3. The method of any of clauses 1 and 2, where the first portion of the resources of the communication bandwidth includes a first portion of the communication bandwidth that is less bandwidth than is currently available from a perspective of the wireless access point for a transmit opportunity and the one or more other portions of the resources of the communication bandwidth includes one or more other portions of the communication bandwidth currently available for the transmit opportunity, where the RTS signal is received in the first portion of the communication bandwidth, and where the trigger signal corresponding to the RTS signal allocates the first portion of the communication bandwidth to the first wireless station for the transmit opportunity and one or more other portions of the communication bandwidth to the one or more other wireless stations for the transmit opportunity.

Clause 4. The method of any of clauses 1-3, where the communication bandwidth includes a first channel, the first portion of the resources of the communication bandwidth includes a first subchannel within the first channel, and the one or more other portions of the resources of the communication bandwidth include one or more other subchannels of the first channel.

Clause 5. The method of clause 4, where the first channel is a 160 MHz bandwidth channel or a 320 MHz bandwidth channel and the first portion of the resources of the communication bandwidth is a 20 MHz bandwidth subchannel or a 40 MHz bandwidth subchannel.

Clause 6. The method of any of clauses 4 and 5, where the first subchannel and the one or more other subchannels span a full bandwidth of the first channel.

Clause 7. The method of any of clauses 1-6, where the trigger signal is configured to solicit the first wireless station and the one or more other wireless stations into transmitting via respective allocated portions of the resources of the communication bandwidth.

Clause 8. The method of any of clauses 1-7, where the trigger signal is

transmitted in accordance with a basic trigger frame of a communication standard implemented by the wireless access point and the plurality of wireless stations.

Clause 9. The method of any of clauses 1-8, may provide for receiving,

from the first wireless station and the one or more other wireless stations of the plurality of wireless stations corresponding to the trigger signal, a MU TB-PPDU.

Clause 10. The method of clause 9, where the MU TB-PPDU utilizes a full

bandwidth of the communication bandwidth.

Clause 11. The method of any of clauses 9 and 10, where the MU TB-PPDU utilizes all bandwidth of the communication bandwidth available for the transmit opportunity.

Clause 12. The method of any of clauses 1-11, where the first wireless station supports a first number of spatial streams that is less than a second number of spatial streams supported by the wireless access point with respect to the communication bandwidth, where the first portion of the resources of the communication bandwidth includes the first number of spatial streams, and where the trigger signal corresponding to the RTS signal allocates the first number of spatial streams in the communication bandwidth to the first wireless station for the transmit opportunity and other spatial streams of the second number of spatial streams in the communication bandwidth to the one or more other wireless stations for the transmit opportunity.

Clause 13. The method of clause 11, where the first number of spatial streams is in a range of 1 to 3 spatial streams, the second number of spatial streams is in a range of 4 to 8 spatial streams, and the other spatial streams include a number of spatial streams of the second number of spatial streams remaining after allocating the first number of spatial streams to the first wireless station.

Clause 14. The method of any of clauses 1-13, may provide for receiving, from the first wireless station and the one or more other wireless stations of the plurality of wireless stations corresponding to the trigger signal, an UL MU-MIMO signal.

Clause 15. The method of clause 14, where the UL MU-MIMO signal utilizes a full bandwidth of the communication bandwidth.

Clause 16. The method of any of clauses 14 and 15, where the UL MU- MIMO signal utilizes all bandwidth of the communication bandwidth available for the transmit opportunity.

Clause 17. A wireless access point, including a processing system that includes one or more processors and one or more memories coupled with the one or more processors, configured, individually or in any combination, to execute the instructions and cause the wireless access point to perform a method in accordance with any one of clauses 1-16.

Clause 18. A wireless access point, including means for performing a method in accordance with any one of clauses 1-16.

Clause 19. A non-transitory computer-readable medium including executable instructions that, when executed by one or more processors of a wireless access point, cause the wireless access point to perform a method in accordance with any one of clauses 1-16.

Clause 20. A computer program product embodied on a computer-readable storage medium including code for performing a method in accordance with any one of clauses 1-16.

Clause 21. A method for wireless communication by a wireless station may provide for transmitting, to a wireless access point, a RTS signal in a first portion of a communication bandwidth in which the wireless access point performs wireless communications with a plurality of wireless stations including the wireless station, and receiving, from the wireless access point, a trigger signal corresponding to the RTS signal for allocating at least a first portion of resources of the communication bandwidth to the wireless station for a transmit opportunity with respect to the communication bandwidth and further allocating one or more other portions of the resources of the communication bandwidth to one or more other wireless stations for the transmit opportunity.

Clause 22. The method of clause 21, where the first portion of the resources of the communication bandwidth and the one or more other portions of the resources of the communication bandwidth meet criteria for communication availability prior to receiving the trigger signal.

Clause 23. The method of any of clauses 21 and 22, where the first portion of the resources of the communication bandwidth includes a first portion of the communication bandwidth that is less bandwidth than is currently available from a perspective of the wireless access point for a transmit opportunity and the one or more other portions of the resources of the communication bandwidth includes one or more other portions of the communication bandwidth currently available for the transmit opportunity, where the RTS signal is transmitted in the first portion of the resources of the communication bandwidth, and where the trigger signal corresponding to the RTS signal allocates the first portion of the communication bandwidth to the wireless station for the transmit opportunity and the one or more other portions of the communication bandwidth to the one or more other wireless stations for the transmit opportunity.

Clause 24. The method of any of clauses 21-23, where the communication bandwidth includes a first channel, the first portion of the resources of the communication bandwidth includes a first subchannel within the first channel, and the one or more other portions of the resources of the communication bandwidth include one or more other subchannels of the first channel.

Clause 25. The method of clause 24, where the first channel is a 160 MHz bandwidth channel or a 320 MHz bandwidth channel and the first portion of the resources of the communication bandwidth is a 20 MHz bandwidth subchannel or a 40 MHz bandwidth subchannel.

Clause 26. The method of any of clauses 24 and 25, where the first subchannel and one or more other subchannels span a full bandwidth of the first channel.

Clause 27. The method of any of clauses 21-26, where the trigger signal is configured to solicit the wireless station and the one or more other wireless stations into transmitting via respective allocated portions of the resources of the communication bandwidth.

Clause 28. The method of any of clauses 21-27, where the trigger signal is in accordance with a basic trigger frame of a communication standard implemented by the wireless access point and the plurality of wireless stations.

Clause 29. The method of any of clauses 21-28, may provide for transmitting, to the wireless access point in correspondence to the trigger signal, a portion of a MU TB-PPDU.

Clause 30. The method of clause 29, where the MU TB-PPDU utilizes a full bandwidth of the communication bandwidth.

Clause 31. The method of any of clauses 29 and 30, where the MU TB- PPDU utilizes all bandwidth of the communication bandwidth available for the transmit opportunity.

Clause 32. The method of any of clauses 21-32, where the wireless station supports a first number of spatial streams that is less than a second number of spatial streams supported by the wireless access point with respect to the communication bandwidth, where the first portion of the resources of the communication bandwidth includes the first number of spatial streams, and where the trigger signal corresponding to the RTS signal allocates the first number of spatial streams in the communication bandwidth to the wireless station for the transmit opportunity and other spatial streams of the second number of spatial streams in the communication bandwidth to the one or more other wireless stations for the transmit opportunity.

Clause 33. The method of clause 32, where the first number of spatial streams is in a range of 1 to 3 spatial streams, the second number of spatial streams is in a range of 4 to 8 spatial streams, and the other spatial streams include a number of spatial streams of the second number of spatial streams remaining after allocating the first number of spatial streams to the wireless station.

Clause 34. The method of any of clauses 21-33, may provide for transmitting, to the wireless access point in correspondence to the trigger signal, a portion of an UL MU-MIMO signal.

Clause 35. The method of clause 34, where the UL MU-MIMO signal utilizes a full bandwidth of the communication bandwidth.

Clause 36. The method of any of clauses 34 and 35, where the UL MU- MIMO signal utilizes all bandwidth of the communication bandwidth available for the transmit opportunity.

Clause 37. A wireless station, including a processing system that includes one or more processors and one or more memories coupled with the one or more processors, configured, individually or in any combination, to execute the instructions and cause the wireless station to perform a method in accordance with any one of clauses 21-36.

Clause 38. A wireless station, including means for performing a method in accordance with any one of clauses 21-36.

Clause 39. A non-transitory computer-readable medium including executable instructions that, when executed by one or more processors of a wireless station, cause the wireless station to perform a method in accordance with any one of clauses 21-36.

Clause 40. A computer program product embodied on a computer-readable storage medium including code for performing a method in accordance with any one of clauses 21-36.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless access point, comprising:
a processing system that includes one or more processors and one or more memories coupled with the one or more processors, the processing system configured to cause the wireless access point to:
receive, from a first wireless station, a request to send (RTS) signal in a communication bandwidth in which the wireless access point performs wireless communications with a plurality of wireless stations including the first wireless station; and
transmit, to the first wireless station and one or more other wireless stations of the plurality of wireless stations, a trigger signal corresponding to the RTS signal for allocating at least a first portion of resources of the communication bandwidth to the first wireless station for a transmit opportunity with respect to the communication bandwidth and further allocating one or more other portions of the resources of the communication bandwidth to the one or more other wireless stations for the transmit opportunity.

2. The wireless access point of claim 1, wherein the processing system is configured to cause the wireless access point to:
sense that the first portion of the resources of the communication bandwidth and the one or more other portions of the resources of the communication bandwidth meet criteria for communication availability.

3. The wireless access point of claim 1, wherein the first portion of the resources of the communication bandwidth comprises a first portion of the communication bandwidth that is less bandwidth than is currently available from a perspective of the wireless access point for the transmit opportunity and the one or more other portions of the resources of the communication bandwidth comprise one or more other portions of the communication bandwidth currently available for the transmit opportunity, wherein the RTS signal is received in the first portion of the communication bandwidth, and wherein the trigger signal corresponding to the RTS signal allocates the first portion of the communication bandwidth to the first wireless station for the transmit opportunity and one or more other portions of the communication bandwidth to the one or more other wireless stations for the transmit opportunity.

4. The wireless access point of claim 3, wherein the communication bandwidth comprises a first channel, the first portion of the resources of the communication bandwidth comprises a first subchannel within the first channel, and the one or more other portions of the resources of the communication bandwidth comprise one or more other subchannels of the first channel.

5. The wireless access point of claim 4, wherein the first channel is a 160 MHz bandwidth channel or a 320 MHz bandwidth channel and the first portion of the resources of the communication bandwidth is a 20 MHz bandwidth subchannel or a 40 MHz bandwidth subchannel.

6. The wireless access point of claim 4, wherein the first subchannel and the one or more other subchannels span a full bandwidth of the first channel.

7. The wireless access point of claim 3, wherein the processing system is further configured to cause the wireless access point to:
receive, from the first wireless station and the one or more other wireless stations of the plurality of wireless stations corresponding to the trigger signal, a multi- user trigger-based physical layer protocol data unit (MU TB-PPDU).

8. The wireless access point of claim 7, wherein the MU TB-PPDU utilizes a full bandwidth of the communication bandwidth.

9. The wireless access point of claim 7, wherein the MU TB-PPDU utilizes all bandwidth of the communication bandwidth available for the transmit opportunity.

10. The wireless access point of claim 1, wherein the first wireless station supports a first number of spatial streams that is less than a second number of spatial streams supported by the wireless access point with respect to the communication bandwidth, wherein the first portion of the resources of the communication bandwidth comprises the first number of spatial streams, and wherein the trigger signal corresponding to the RTS signal allocates the first number of spatial streams in the communication bandwidth to the first wireless station for the transmit opportunity and other spatial streams of the second number of spatial streams in the communication bandwidth to the one or more other wireless stations for the transmit opportunity.

11. The wireless access point of claim 10, wherein the first number of spatial streams is in a range of 1 to 3 spatial streams, the second number of spatial streams is in a range of 4 to 8 spatial streams, and the other spatial streams comprise a number of spatial streams of the second number of spatial streams remaining after allocating the first number of spatial streams to the first wireless station.

12. The wireless access point of claim 10, wherein the processing system is further configured to cause the wireless access point to:
receive, from the first wireless station and the one or more other wireless stations of the plurality of wireless stations corresponding to the trigger signal, an uplink multi-user multiple-input multiple-output (UL MU-MIMO) signal.

13. The wireless access point of claim 12, wherein the UL MU-MIMO signal utilizes a full bandwidth of the communication bandwidth.

14. The wireless access point of claim 12, wherein the UL MU-MIMO signal utilizes all bandwidth of the communication bandwidth available for the transmit opportunity.

15. A wireless station, comprising:
a processing system that includes one or more processors and one or more memories coupled with the one or more processors, the processing system configured to cause the wireless station to:
transmit, to a wireless access point, a request to send (RTS) signal in a communication bandwidth in which the wireless access point performs wireless communications with a plurality of wireless stations including the wireless station; and
receive, from the wireless access point, a trigger signal corresponding to the RTS signal for allocating at least a first portion of resources of the communication bandwidth to the wireless station for a transmit opportunity with respect to the communication bandwidth and further allocating one or more other portions of the resources of the communication bandwidth to one or more other wireless stations for the transmit opportunity.

16. The wireless station of claim 15, wherein the first portion of the resources of the communication bandwidth and the one or more other portions of the resources of the communication bandwidth meet criteria for communication availability prior to receiving the trigger signal.

17. The wireless station of claim 15, wherein the first portion of the resources of the communication bandwidth comprises a first portion of the communication bandwidth that is less bandwidth than is currently available from a perspective of the wireless access point for the transmit opportunity and the one or more other portions of the resources of the communication bandwidth comprise one or more other portions of the communication bandwidth currently available for the transmit opportunity, wherein the RTS signal is transmitted in the first portion of the resources of the communication bandwidth, and wherein the trigger signal corresponding to the RTS signal allocates the first portion of the communication bandwidth to the wireless station for the transmit opportunity and the one or more other portions of the communication bandwidth to the one or more other wireless stations for the transmit opportunity.

18. The wireless station of claim 15, wherein the communication bandwidth comprises a first channel, the first portion of the resources of the communication bandwidth comprises a first subchannel within the first channel, and the one or more other portions of the resources of the communication bandwidth comprise one or more other subchannels of the first channel.

19. The wireless station of claim 18, wherein the first channel is a 160 MHz bandwidth channel or a 320 MHz bandwidth channel and the first portion of the resources of the communication bandwidth is a 20 MHz bandwidth subchannel or a 40 MHz bandwidth subchannel.

20. The wireless station of claim 18, wherein the first subchannel and the one or more other subchannels span a full bandwidth of the first channel.

21. The wireless station of claim 15, wherein the processing system is further configured to cause the wireless station to:
transmit, to the wireless access point in correspondence to the trigger signal, a portion of a multi-user trigger-based physical layer protocol data unit (MU TB-PPDU).

22. The wireless station of claim 21, wherein the MU TB-PPDU utilizes a full bandwidth of the communication bandwidth.

23. The wireless station of claim 21, wherein the MU TB-PPDU utilizes all bandwidth of the communication bandwidth available for the transmit opportunity.

24. The wireless station of claim 15, wherein the wireless station supports a first number of spatial streams that is less than a second number of spatial streams supported by the wireless access point with respect to the communication bandwidth, wherein the first portion of the resources of the communication bandwidth comprises the first number of spatial streams, and wherein the trigger signal corresponding to the RTS signal allocates the first number of spatial streams in the communication bandwidth to the wireless station for the transmit opportunity and other spatial streams of the second number of spatial streams in the communication bandwidth to the one or more other wireless stations for the transmit opportunity.

25. The wireless station of claim 24, wherein the first number of spatial streams is in a range of 1 to 3 spatial streams, the second number of spatial streams is in a range of 4 to 8 spatial streams, and the other spatial streams comprise a number of spatial streams of the second number of spatial streams remaining after allocating the first number of spatial streams to the wireless station.

26. The wireless station of claim 24, wherein the processing system is further configured to cause the wireless station to:
transmit, to the wireless access point in correspondence to the trigger signal, a portion of an uplink multi-user multiple-input multiple-output (UL MU-MIMO) signal.

27. The wireless station of claim 26, wherein the UL MU-MIMO signal utilizes a full bandwidth of the communication bandwidth.

28. The wireless station of claim 26, wherein the UL MU-MIMO signal utilizes all bandwidth of the communication bandwidth available for the transmit opportunity.

29. A method for wireless communication by a wireless access point, comprising:
receiving, from a first wireless station, a request to send (RTS) signal in a communication bandwidth in which the wireless access point performs wireless communications with a plurality of wireless stations including the first wireless station; and
transmitting, to the first wireless station and one or more other wireless stations of the plurality of wireless stations, a trigger signal corresponding to the RTS signal for allocating at least a first portion of resources of the communication bandwidth to the first wireless station for a transmit opportunity with respect to the communication bandwidth and further allocating one or more other portions of the resources of the communication bandwidth to the one or more other wireless stations for the transmit opportunity.

30. A method for wireless communication by a wireless station, comprising:
transmitting, to a wireless access point, a request to send (RTS) signal in a communication bandwidth in which the wireless access point performs wireless communications with a plurality of wireless stations including the wireless station; and
receiving, from the wireless access point, a trigger signal corresponding to the RTS signal for allocating at least a first portion of resources of the communication bandwidth to the wireless station for a transmit opportunity with respect to the communication bandwidth and further allocating one or more other portions of the resources of the communication bandwidth to one or more other wireless stations for the transmit opportunity.
